(19) United States
(12) Patent Application Publication
(10) Pub. No.: US 2005/0063793 A1
(43) Pub. Date: Mar. 24, 2005

(54) Boring drill for toy model

(76) Inventor: Aling Lai, Taichung (TW)

Correspondence Address: Aling Lai, P.O. Box 2103, Taichung, TW

(21) Appl. No.: 10/667,380

(22) Filed: Sep. 24, 2003

(51) Int. Cl. B23B 51/00

(52) U.S. Cl. 408/226

(57) ABSTRACT

A boring drill for toy model includes a conic drill bit. A connecting rod extends from one end of the drill bit for connecting with a drive for rotationally driving the drill bit. The drill bit has at least one blade section and marked face. Scales and sizes denoting the scales are marked on the marked face for measuring the diameter of the bore. Each scale corresponds to the diameter of the bore drilled by the drill bit. The size denoting each scale shows the size of the diameter of the bore drilled by the drill bit.

### BACKGROUND OF THE INVENTION

The present invention is related to a boring drill for toy model, and more particularly to a boring drill in which scales representing the diameter of the drilled bore are marked on a marked face of the drill bit. Therefore, when drilling bores on a toy model for changing the toy model, a user can simultaneously know the diameter of the bore.

When changing a toy model, for example, replacing the casing of a remote controllable model car with a new casing, it is often necessary to drill some circular bores on the casing, which are adapted to the car frame, whereby the casing can be assembled with the car frame. However, the casing is not a plane board body and is curved by a certain curvature. Therefore, it is uneasy to drill bores on the casing with a drilling machine. Accordingly, a manually operable boring drill has been developed for drilling bores on the casing of the toy model. As shown in FIG. 7, such manually operable boring drill includes a drill bit 6 connected with a stem 7 for a user to hold. The drill bit 6 is a sharp conic body and generally has two blade sections 61. In use, a user holds the stem 7 to press the tip of the drill bit 6 against the casing of the model car. Then the user forcedly rotates the drill bit 6, whereby the blade sections 61 of the drill bit 6 drill a desired circular bore on the casing.

When drilling circular bore on the casing with the boring drill, the user cannot simultaneously know the diameter of the drilled circular bore. The user needs to use an additional measuring tool to measure the diameter of the bore. In order to avoid error of the diameter of the drilled bore, after drilling to a certain depth, the user needs to first extract the drill bit and then measure the diameter of the bore. This is quite inconvenient. Furthermore, it often takes place that the bore is over-drilled so that the diameter of the drilled bore is larger than the desired diameter. This will affect the precision of change of the model car.

### SUMMARY OF THE INVENTION

It is therefore a primary object of the present invention to provide a boring drill for toy model, including a conic drill bit. A connecting rod extends from one end of the drill bit for connecting with a drive for rotationally driving the drill bit. The drill bit has at least one blade section and marked face. Scales and sizes denoting the scales are marked on the marked face for measuring the diameter of the bore. Each scale corresponds to the diameter of the bore drilled by the drill bit. The size denoting each scale shows the size of the diameter of the bore drilled by the drill bit.

The scales and sizes are marked on the marked face of the solid conic drill bit for measuring the diameter of the bore. The scales and sizes marked on the marked face are transformed from the angle and radius of different portions of the inclined blade sections. The scales represent the diameter of the bore drilled on the work piece. Therefore, when the user drills the bore on the work piece, the user can simultaneously know the diameter of the bore without further measuring the diameter of the bore after drilling the bore. This enhances the convenience in use and ensures the precision of the size of the bore drilled on the work piece.

The present invention can be best understood through the following description and accompanying drawings wherein:

### BRIEF DESCRIPTION OF THE DRAWINGS

FIG. 1 is a perspective view of the present invention;

FIG. 2 is a perspective exploded view of the present invention;

FIG. 3 is a sectional assembled view of the present invention;

FIG. 4 is a top view of the present invention, showing the drill bit of the present invention;

FIG. 5 shows the metric system scales and sizes marked on the marked face of the present invention;

FIG. 6 shows the British system scales and sizes marked on the marked face of the present invention; and

FIG. 7 shows a conventional boring drill.

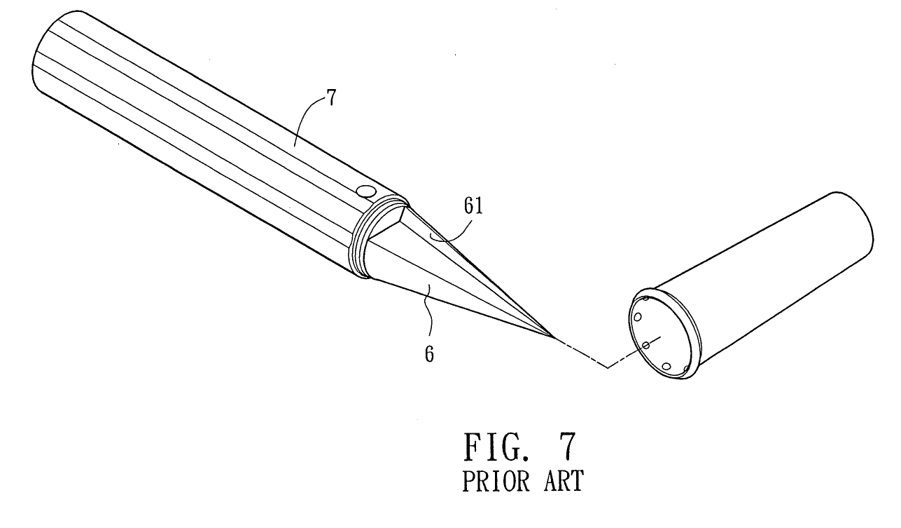

### DETAILED DESCRIPTION OF THE PREFERRED EMBODIMENT

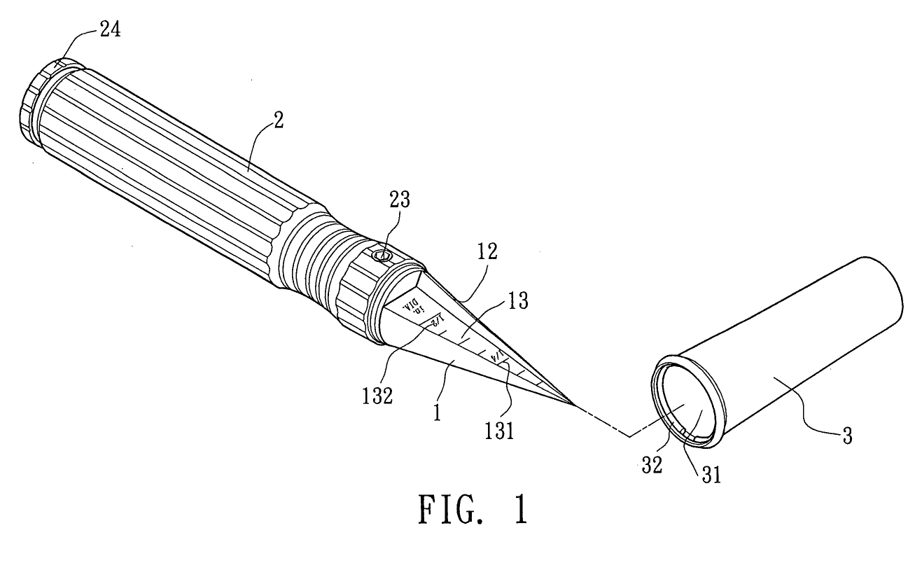

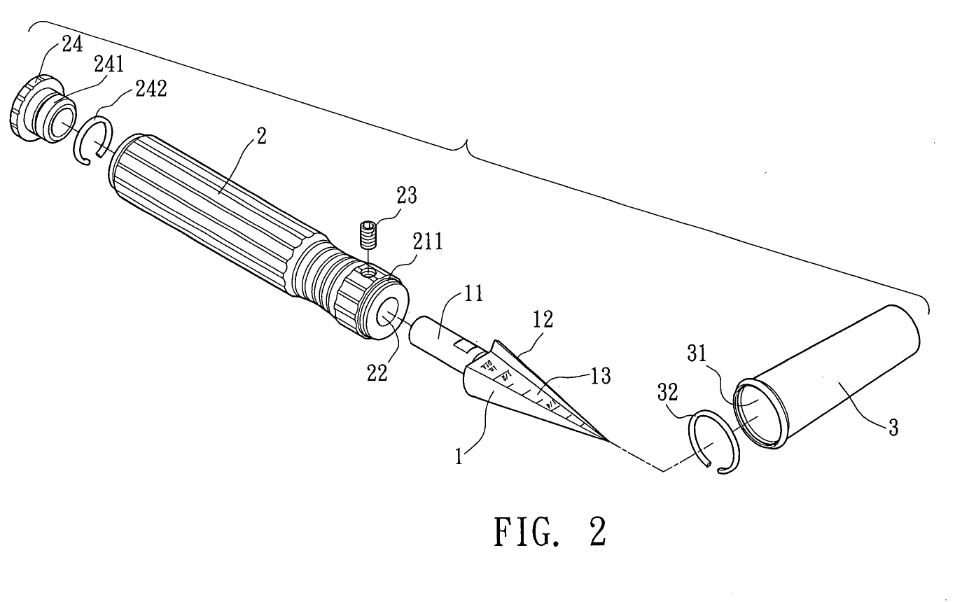

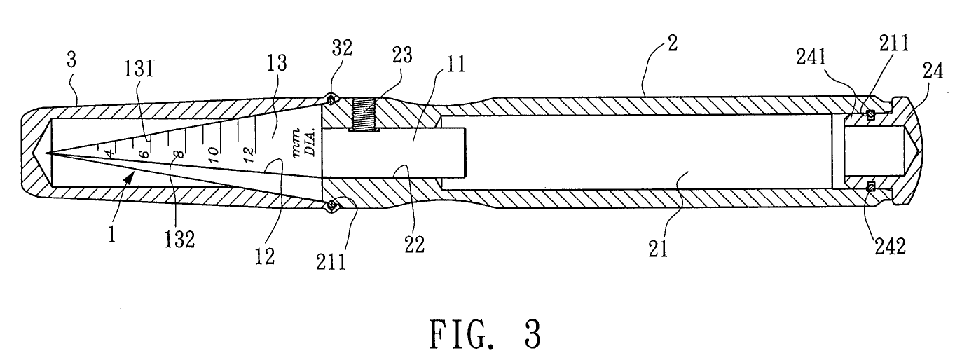

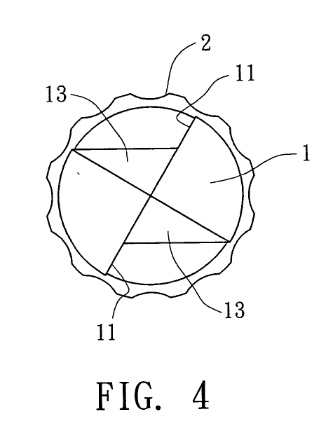

Please refer to FIGS. 1 to 4. The boring drill for toy model of the present invention includes a substantially conic drill bit 1. A connecting rod 11 extends from one end of the drill bit 1 for connecting with a drive for rotationally driving the drill bit 1. In this embodiment, the drive is a stem 2 for a user to hold and manually rotationally drive the drill bit 1. Alternatively, the drive can be a pneumatic tool for pneumatically rotationally driving the drill bit 1. A jacket 3 is used to cover and protect the drill bit 1.

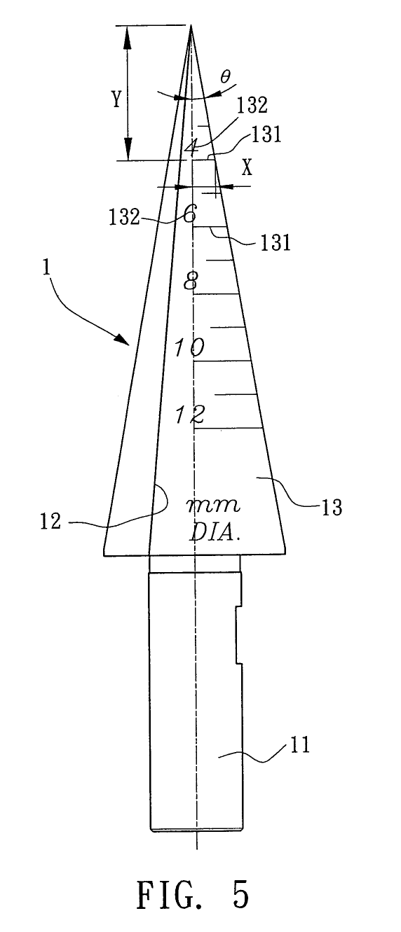

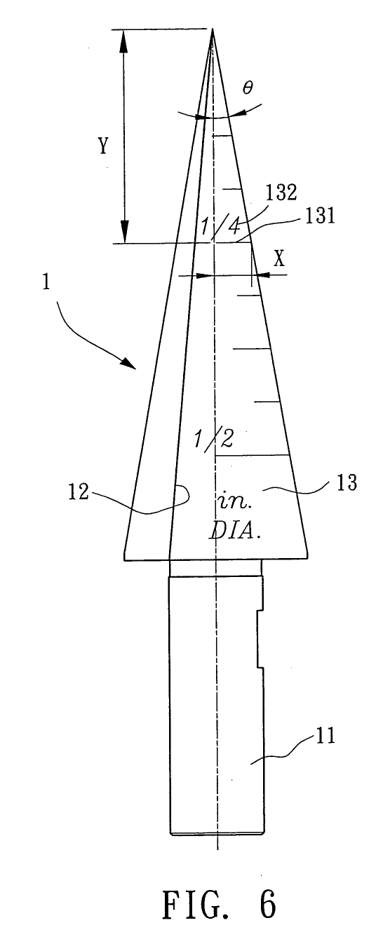

The drill bit 1 has at least one blade section 12 and a marked face 13. In this embodiment, each of two sides of the drill bit 1 has a marked face 13. Blade sections 12 respectively extend from opposite sides of the marked faces 13. Scales 131 and sizes 132 denoting the scales 131 are marked on the marked face 13 for measuring the diameter of the bore. In this embodiment, the marked faces 13 are respectively marked with British and metric system scales 131 and sizes 132. Referring to FIGS. 5 and 6, each scale 131 corresponds to the diameter of the bore drilled by the drill bit 1. The size 132 denoting each scale 131 shows the size of the diameter of the bore drilled by the drill bit 1. The position Y where the scale is marked is obtained from a formula Y=X/tan θ, wherein θ is the known one half of the angle of the tip of the drill bit 1 and X is the known radius of the drill bit 1.

The stem 2 has an interior space 21. A fitting hole 22 outward extends from one end of the interior space 21. The connecting rod 11 of the drill bit 1 is fitted in the fitting hole 22. A fixing member 23 is radially locked in one side of the fitting hole 22 of the stem 2. The fixing member 23 serves to tightly abut against the connecting rod 111 of the drill bit 1 to integrally connect the drill bit 1 with the stem 2. A rear cap 24 is rotatably disposed at the other end of the interior space 21 for sealing the interior space 21. The rear cap 24 has a projecting boss 241 extending into the interior space 21. A C-shaped ring 242 is inlaid in the projecting boss 241. The wall of the interior space 21 is formed with an annular groove 211 corresponding to the C-shaped ring 242. The C-shaped ring 242 is engaged in the annular groove 211, whereby the rear cap 24 is rotatably fitted in and connected with the rear end of the stem 2. The outer circumference of the front end of the stem 2 is also formed with an annular groove 211.

The jacket 3 has an opening 31 through which the jacket 3 can be fitted around the drill bit 1. A C-shaped ring 32 is inlaid in the wall of the opening 31. The C-shaped ring 32 can be engaged in the annular groove 211 of the front end of the stem 2 to locate the jacket 3 at front end of the stem 2.

In use, a user holds the stem 2 to press the tip of the drill bit 1 against a work piece to be drilled. Then the user forcedly rotates the drill bit 1, whereby the blade sections 12 of the drill bit 1 drill a desired circular bore on the work piece. By means of the scales and sizes marked on the marked face 13, the user can know the present size of the diameter of the bore drilled on the work piece.

According to the above arrangements, the scales 131 and sizes 132 are marked on the marked face 13 of the drill bit 1 for measuring the diameter of the bore. Therefore, when the user drills the bore on the work piece, the user can simultaneously know the diameter of the bore. This enhances the convenience in use and ensures the precision of the size of the bore drilled on the work piece.

It should be noted that the scales marked on the marked face of the solid conic drill bit is transformed from the angle and radius of different portions of the inclined blade sections. The scales represent the diameter of the bore drilled on the work piece. Therefore, when the user drills the bore on the work piece, the user can simultaneously know the diameter of the bore without further measuring the diameter of the bore after drilling the bore.

The above embodiment is only used to illustrate the present invention, not intended to limit the scope thereof. Many modifications of the above embodiment can be made without departing from the spirit of the present invention.

1. A boring drill for toy model, comprising a conic drill bit, a connecting rod extending from one end of the drill bit for connecting with a drive for rotationally driving the drill bit, the drill bit having at least one blade section and marked face, scales and sizes denoting the scales being marked on the marked face for measuring the diameter of the bore, each scale corresponding to the diameter of the bore drilled by the drill bit, the size denoting each scale showing the size of the diameter of the bore drilled by the drill bit.

2. The boring drill for toy model as claimed in claim 1, wherein each of two sides of the drill bit has a marked face, blade sections respectively extending from opposite sides of the marked faces, scales and sizes denoting the scales being marked on the marked face for measuring the diameter of the bore.

3. The boring drill for toy model as claimed in claim 1, wherein the drive connected with the connecting rod of the drill bit is a stem for a user to hold and manually rotationally drive the drill bit, the stem having an interior space, a fitting hole outward extending from one end of the interior space, the connecting rod of the drill bit being fitted in the fitting hole, a fixing member being radially locked in one side of the fitting hole of the stem for tightly abutting against the connecting rod of the drill bit to integrally connect the drill bit with the stem, a rear cap being rotatably disposed at the other end of the interior space for sealing the interior space.

4. The boring drill for toy model as claimed in claim 3, wherein the rear cap has a projecting boss extending into the interior space, a C-shaped ring being inlaid in the projecting boss, a wall of the interior space being formed with an annular groove corresponding to the C-shaped ring, the C-shaped ring being engaged in the annular groove, whereby the rear cap is rotatably fitted in and connected with the rear end of the stem.

5. The boring drill for toy model as claimed in claim 3, wherein a jacket is fitted on the stem to cover the drill bit, the jacket having an opening through which the jacket is fitted around the drill bit, a C-shaped ring being inlaid in a wall of the opening of the jacket, a front end of the stem being formed with an annular groove in which the C-shaped ring can be engaged to locate the jacket at front end of the stem for protecting the drill bit.
